(19) United States
(12) Patent Application Publication
(10) Pub. No.: US 2020/0314035 A1
(43) Pub. Date: Oct. 1, 2020

(54) METHOD AND SYSTEM FOR DETERMINING TARGET BITRATE USING CONGESTION CONTROL BASED ON FORWARD PATH STATUS

(71) Applicant: LINE PLus Corporation, Seongnam-si (KR)

(72) Inventor: Jungnam GWOCK, Seongnam-si (KR)

(73) Assignee: LINE PLus Corporation, Seongnam-si (KR)

(21) Appl. No.: 16/536,867

(22) Filed: Aug. 9, 2019

(30) Foreign Application Priority Data
Mar. 26, 2019 (KR) 10-2019-0034125

(51) Int. Cl. H04L 12/861; H04L 12/801; H04L 12/26

(52) U.S. Cl. CPC H04L 49/90; H04L 43/08; H04L 43/16; H04L 47/12

(57) ABSTRACT

A method is provided for determining target transmit rate for a forward path for packet transmission to a receiver, performed at a transmitter and includes receiving, from the receiver, a feedback message including information on a packet previously transmitted by the transmitter, estimating a metric for determining a status of the forward path based on the received feedback message, determining the status of the forward path based on the metric, determining the target transmit rate for the forward path based on the status of the forward path, and controlling a transmit rate by the transmitter of the packet to the receiver at the target transmit rate, wherein the metric reflects characteristics associated with the forward path from which influence by a backward path which is a path that the feedback message is transmitted is removed.

### CROSS REFERENCE TO RELATED APPLICATION

This application claims the priority benefit of Korean Patent Application No. 10-2019-0034125, filed on Mar. 26, 2019, in the Korean Intellectual Property Office, the disclosure of which is incorporated herein by reference.

### BACKGROUND

### 1. Technical Field

The present disclosure relates to a technology for determining target transmit rate (bitrate) for a forward path, such as a technology for controlling transmit rate of a transmitter by determining target transmit rate for a forward path through congestion control based on a forward path status.

### 2. Description of Related Art

RTP (Real-Time transport Protocol) is an application/transport layer protocol used for real-time transport of data in a VoIP (Voice over Internet Protocol) and the like. Guaranteeing low latency in this real-time transport of data is one of the main factors indicating performance of real-time transport of data. However, various unpredictable situations in the network make it difficult to guarantee low latency.

According to today's technology development and diversification of media, an amount of communicated traffic rapidly increases. As the traffic increases, the burden on the network may increase, and may lead to high latency.

Therefore, in a real-time data transmission environment, to predict resources of the network and make resource usage more efficient, it may be advantageous to determine a target transmit rate suitable for a forward path status and accordingly control a transmit rate of the transmitter.

### SUMMARY

At least some example embodiments include a method of enabling a transmitter to communicate with a receiver, wherein the method includes estimating a metric reflecting characteristics associated with a forward path from which influence by a backward path which is a path that a feedback message is transmitted based on the feedback message received from the receiver, determining a status of the forward path based on the metric, determining a target transmit rate for the forward path, and controlling a transmit rate by the transmitter of the packet to the receiver at the target transmit rate.

At least some example embodiments include a method of enabling a transmitter to communicate with a receiver at a target transmit rate for a forward path for packet transmission to the receiver, wherein the method includes receiving, from the receiver, a feedback message including information on a packet previously transmitted by the transmitter, estimating a metric for determining a status of the forward path based on the feedback message, determining the status of the forward path based on the metric, determining the target transmit rate for the forward path based on the status of the forward path, and controlling a transmit rate by the transmitter of the packet to the receiver at the target transmit rate, wherein the metric reflects characteristics associated with the forward path from which influence by a backward path which is a path that the feedback message is transmitted is removed.

In some example embodiments, the status of the forward path may be a throttled status, a probing status, a competing status, or a default status, the determining target transmit rate may include determining the target transmit rate to empty queue by lowering the transmit rate by the transmitter of the packet to the receiver in response that the status of the forward path is the throttled status, determining the target transmit rate to keep a queue latency below a target queue latency in response that the status of the forward path is the competing status or the default status, and determining the target transmit rate to increase the transmit rate by the transmitter of the packet to the receiver to determine a bottlenecked bandwidth of the forward path in response that the status of the forward path is the probing status.

In some example embodiments, throttled status may indicate a status that the transmit rate by the transmitter of the packet to the receiver is larger than bandwidth limitation of the forward path, the competing status may indicate a status that cross traffics are detected, the probing status may indicate a status that the transmit rate by the transmitter of the packet to the receiver is below the bandwidth limitation, and the default status may indicate a status of the forwarding path which is neither the throttled status, the probing status, nor the competing status.

In some example embodiments, estimating the metric may include estimating the bandwidth of the forward path and queue delay.

In some example embodiments, the feedback message may be periodically received, estimating the metric may include estimating the bandwidth and queue delay of the forward path, the status of the forward path may be determined as the probing status in response that the queue delay lasts for a first time that is below a first threshold, the status of the forward path may be determined as the competing status in response that the queue delay lasts for a second time that is above the first threshold, and the status of the forward path may be determined as the throttled status in response that the queue delay increases at a rate above a second threshold and the bandwidth of the forward path decreases.

In some example embodiments, the feedback message may be periodically received, and the estimating metric may include estimating the bandwidth of the forward path, the determining target transmit rate may include, in response that the status of forward path is the competing status, determining the target transmit rate based on target bandwidth may be determined by a first equation:

Target bandwidth=Estimated bandwidth of forward path*N%, wherein N is a real number greater than 50 and less than 100 [Equation 1]:

In some example embodiments, in response that the status of forward path is the throttled status, the target transmit rate based on target bandwidth may be determined by a second equation:

Target bandwidth=Estimated bandwidth of forward path*0.5 [Equation 2]:

In response that the status of forward path is the probing status, determining the target transmit rate based on target bandwidth may be determined by a third equation:

Target bandwidth=Estimated bandwidth of forward path*(1+alpha), wherein the alpha is a real number greater than 0 [Equation 3]:

In some example embodiments, in response that the status of the forward path is the default status, the target transmit rate may be based on target bandwidth corresponding to the estimated bandwidth of the forward path.

In some example embodiments, estimating the metric may include checking validation of the feedback message, parsing the feedback message, obtaining brFraction (bitrate Fraction) corresponding to ratio of a size of the packet received by the receiver to a size of the packet transmitted by the transmitter, based on data included in the feedback message, estimating the bandwidth of the forward path based on the brFraction, and estimating Qdelay (queue delay) and QMrange (queue delay range) for the forward path, and the determining status of the forward path may include determining the status of the forward path based on an event defined for determining a status of the forward path, the estimated bandwidth of the forward path, the Qdelay, and/or the QMrange.

In some example embodiments, the feedback message may include a report block including a RTCP header, a Rxer ID, a Txer ID, a feedback message header, and data for a reported packet.

In some example embodiments, the feedback message header may include a report time field, a feedback sequence field, and a monitored time field, and the report time field may include a value indicating system uptime of the transmitter as report time, the feedback sequence field may include a value indicating sequence number of the feedback sequence, and the monitored time field may include a value indicating a duration observed to generate the feedback message as monitored time.

In some example embodiments, the report block may include an SSRC field including a value indicating SSRC of the reported packet, a report packet count field including a value indicating count of the reported packet, an end-seq (end sequence) field including a value indicating last sequence number of the reported packet, a L field including a value indicating whether packet is lost, and an ATO (Arrival Time Offset) field including a value indicating a relative time distance of reception time of the reported packet to the report time.

In some example embodiments, the report block may include an SSRC field including a value indicating SSRC of the reported packet, a report packet count field including a value indicating count of the reported packet, a start sequence number field including a value indicating start sequence number of the reported packet, and a Pkt-Element field including a value indicating information for each reported packet.

In some example embodiments, based on the report time and the value of the end-seq field, a packet transmitted from the transmitter before receiving the feedback message after a transmission of a packet corresponding to the value of the end-seq field may not be considered in the estimating the metric.

In some example embodiments, a packet transmitted from the transmitter during time corresponding to a value of an ATO field of a packet corresponding to the value of the end-seq field after a transmission of the packet corresponding to the value or the end-seq field may be considered in the estimating the metric.

In some example embodiments, the metric may be estimated and the status of the forward path may be determined based on time when the receiver transmits the feedback message, rather than time when the transmitter receives the feedback message.

In some example embodiments, determining the target transmit rate may further include transmitting a control message for requesting a specific feature to the receiver, and a response may be made from the receiver in response that the control message has a message type that the receiver is able to understand.

In some example embodiments, feedback messages may be periodically received based on a feedback interval time (which may be identifiable, desired, and/or predetermined), the feedback interval time may be set from the transmitter, the monitored time as a duration observed to generate the feedback message may be set from the transmitter, and the monitored time may be greater than or equal to the feedback interval time.

In some example embodiments, a status of a forward path for packet transmission may be classified as one of throttled status, competing status, probing status, and default status.

In some example embodiments, by reducing or minimizing influence by a backward path in which a feedback message is transmitted, a more accurate understanding for a status of a forward path for the forward path for packet transmission and determining target transmit rate may be performed.

### BRIEF DESCRIPTION OF THE DRAWINGS

These and/or other aspects, features, and advantages of the present disclosure will become apparent and more readily appreciated from the following description of some example embodiments, taken in conjunction with the accompanying drawings of which:

FIG. 1 illustrates a CCFS feedback message format according to some example embodiments;

FIG. 2 illustrates a CCFS feedback message header according to some example embodiments;

FIG. 3 illustrates a CCFS feedback report block according to some example embodiments;

FIG. 4 illustrates a CCFS Pkt-element according to some example embodiments;

FIG. 5 illustrates another example of a CCFS feedback message format according to some example embodiments;

FIG. 6 illustrates a status change diagram for statuses according to some example embodiments;

FIG. 7 illustrates a status change diagram for statuses according to some example embodiments;

FIG. 8 illustrates a control message format according to some example embodiments;

FIG. 9 illustrates a method for transmitting a packet and a feedback packet message between a transmitter and a receiver according to some example embodiments;

FIG. 10 is an algorithm illustrating a method for estimating FwdBW according to some example embodiments;

FIG. 11 is an algorithm illustrating a method for processing an event related to throttled status according to some example embodiments;

FIG. 12 is an algorithm illustrating a method for processing an event related to competing status according to some example embodiments;

FIG. 13 is an algorithm illustrating a method for processing an event related to probing status according to some example embodiments;

FIG. 14 is a block diagram illustrating an internal configuration of a transmitter and a receiver according to some example embodiments;

FIG. 15 is a flow chart illustrating a method for determining target transmit rate according to some example embodiments;

FIG. 16 is a flow chart illustrating a method for estimating a metric for determining a status of a forward path according to some example embodiments;

FIG. 17 is a flow chart illustrating a method for enabling a receiver to transmit a feedback message according to some example embodiments.

### DETAILED DESCRIPTION

Hereinafter, some example embodiments will be described in detail with reference to the accompanying drawings. Regarding the reference numerals assigned to the elements in the drawings, the same or similar elements will be designated by the same reference numerals. The terminology “time” in the following detailed description may be used to indicate a specific point or time as well as between from one time to another time.

In many scenarios, interactive multi-media applications occur between two or more devices, in which each device may act as a transmitter (“Txer”) and/or as a receiver (“Rxer”). Modalities that may be provided in the multi-media application include, for example, text, still images, video, sound, and haptic input/output. Such scenarios may include one-to-one communication between two devices; one-to-many communication from one transmitter to a plurality of receivers; many-to-one communication from a plurality of transmitters to one receiver; and/or many-to-many communication, such as from a plurality of transmitters to a plurality of receivers or a group communication session among a set of devices. In various scenarios, a device may be designated as only a receiver; as only a transmitter; as a transmitter at some times and as a receiver at other times; and/or as a transceiver that functions concurrently as both a transmitter and a receiver. Such devices may communicate over a variety of communication architectures and topologies, such as point-to-point or peer-to-peer, server/client, and a network architecture such as wide area network (e.g., the Internet) or a local area network (LAN), or a combination thereof. Such communications sessions may occur over various communication media, such as wired communication over fiber-optic, coaxial, or Ethernet cabling, and/or wireless communication using protocols such as 3G, 5G, LTE, WiFi, Bluetooth, etc.

Within such scenarios, the quality of the communication session may be based on technical factors such as latency (for example, the delay between the transmission of data by a transmitter and the receipt and presentation of such data by a receiver), throughput (for example, the bitrate of media data sent by a transmitter and received by the receiver, where higher-bitrate media may present a higher-resolution image or higher-fidelity audio), and consistency (for example, the presence or absence of delays in a continuous transmission of media data and/or variance in the bitrate of a variable-bitrate transmission). Some communication sessions may occur in a realtime context, wherein it may be advantageous to reduce latency. Some technical considerations that may affect the capability of the devices in a communication session to achieve and maintain a high-quality communication session, such as in realtime multi-media communication sessions, include the bitrate at which a transmitter transmits data to a receiver, which in turn may depend upon the capacity of the communication media therebetween. If the bitrate is too low, then the quality of the presentation transmitted from the transmitter to the receiver may be undesirably lower than an achievable quality using a higher bitrate; and if the bitrate is too high, then the receiver may experience delays in the receipt and rendering of data, such as an increase in latency and/or a reduction in consistency. Further, the selection of the bitrate by the transmitter may be affected, for example, by factors such as variance in the capacity of the communication media between the transmitter and the receiver. Thus, in some scenarios, it may be advantageous to enable the transmitter to utilize a transmission bitrate that promotes reduced latency, high media quality, and/or consistency of the data transmission that is thus received and presented by the receiver.

Below, a CCFS (Congestion Control based on Forward path Status) is described based on a forward path status, and a rate adaption scheme for interactive real-time media applications, such as video conference. The CCFS classifies the status of the forward path as throttled status, competing status, probing status, and default status which are controlled based on estimated parameters such as bottleneck bandwidth, queue delay and loss ratio. Considering only the forward path status may reduce or minimize influence by network events of a backward path (e.g., a path that a feedback message is received) such as congestion. It is also free from compatibility issues since a generalized feedback message is defined.

Interactive real-time multi-media applications may control their transmit rates to adapt to bandwidth changes and maintains low queuing delay over the network. Many metrics, such as RTT, packet loss and ECN (Explicit Congestion Notification), may be used to evaluate a current network condition. Some example embodiments may include estimating one metric, whereas other example embodiments may include estimating a plurality of metrics.

Real-time communication applications may have two streaming paths—a forward path to send media and a backward path to receive media. Moreover, each path is independent in most of the cases. For example, if congestion occurs in the backward path, the transmit rate on the forward path may not be reduced. However, if RTT is used for congestion control, RTT could be affected by not only the latency of the forward path but the latency of the backward path. Although it is used to control a transmit rate, a metric or behavior such as RTT may be affected by the status of the backward path and may lead to a wrong decision.

The CCFS may use metrics reflecting only the characteristic of the forward path in its algorithm to remove the influence of conditions of the backward path. The CCFS is a sender-based method to be free from compatibility issues. That is, coexistence of multiple CCFS sender versions may be available because of algorithm variations or any other issues. To achieve this, passive behavior of CCFS receiver and generalized feedback mechanisms are defined below.

Below, a technology overview that may be related to some example embodiments is described.

There are two modules to carry out a CCFS—Txer and Rxer. Txer is an abbreviation for transmitter of the CCFS and Rxer means a receiver of the CCFS. Txer may have a main active role to control the transmitting bitrate by examining CCFS feedback messages from an associated Rxer. The Rxer operates passively except when sending periodic CCFS feedback messages. The Txer and the Rxer manage multiple RTP streams if they are able to share network paths. For example, multiple RTP streams using same 4 tuple (or 5 tuple)—a source IP, a source port, a destination IP and a destination port—may be associated with one Txer and Rxer.

To start the CCFS, the Txer and the Rxer may complete CCFS negotiation. Negotiation may be accomplished on an external channel before associating RTP session is established.

The Rxer sends a periodic CCFS feedback message if CCFS feature is negotiated. The Txer may estimate various metrics, mainly 3 metrics—bottleneck bandwidth, queue latency and loss ratio. Then, it makes a decision on the status of the forward path, which is one of throttled, probing, competing, and default. The Txer may operate target transmit rate based on the status of the forward path.

Each status of the forward path may be as follows.

Throttled status: detected the network queue is filling up. The current transmit rate may be lowered to empty the queue.

Competing status: detected cross traffics. That is, a status in which another node is interrupted in the path. The current transmit rate may be controlled to keep the queue latency below a target queue latency. The transmit rate may not be reduced too rapidly to prevent or reduce starvation.

Probing status: the bottlenecked bandwidth of the forward path may be larger than the estimated bandwidth. The current transmit rate may be increased to probe the bottlenecked bandwidth. In other words, the transmit rate may be further increased because there is space in the probing status.

Default status: does not belong to above 3 statuses. The current transmit rate may be controlled to keep the queue latency below a target queue latency.

While the probing status, the transmit rate may be increased to probe available bandwidth. However, it may lead to congestion and this may harm the media quality. To reduce or minimize the side effects, sending redundant packets like FEC packets is recommended.

Below, some example embodiments that may relate to a CCFS related example are described in detail.

In some example embodiments, the CCFS may be negotiated before run. It may be appreciated that those of ordinary skill in the art may understand various ways of performing such negotiation, such as SDP negotiation or an application-defined protocol. Some parameters that may be decided from negotiation are described as follow.

1. Txer ID (4 bytes): ID of CCFS Txer may be decided. This is used as SSRC in RTCP messages used by the CCFS. So, this value may be unique among SSRCs of transmitting RTP streams.

2. Rxer ID (4 bytes): Also, the Rxer associated with the Txer may have its own ID to use as SSRC in RTCP messages.

3. Preferred feedback interval time: The Rxer may know initial feedback interval time. This interval may be changed by the Txer in the session.

4. Preferred monitoring time: A feedback message may have information of received packets for this recent monitored time.

5. Lower-layer protocol: RTP packets may be sent on the UDP stack in most case. However, it may be sent on other transport layers depending on an application selection or requirement. A different congestion control mechanism for difference lower-layer protocol stack may be reasonable. To decide which congestion control mechanism may be used, the transport layers of both Rxer and Txer may be utilized. The CCFS described in the present disclosure supposes only UDP. However, CCFS Txer may be modified for other transport layers.

Below, the Rxer is described in detail.

The Rxer may know the interval time and the default time may be, for example, 100 msec. The feedback interval time may be changed by a RTCP message sent by the Txer.

The Rxer may not send feedbacks if it has not received any packets and has not sent a feedback before, even when the feedback interval time is passed. However, the Rxer may periodically send feedbacks once it has started sending feedback messages. Also, the Rxer may send a feedback even when there is no received packet for the last feedback interval time because it could be an important signal.

If a feedback message size may be bigger than MTU size, promptly or immediately the Rxer may send the feedback even before arriving the next feedback interval time.

Below, a feedback message format generated on the receiver is described in detail.

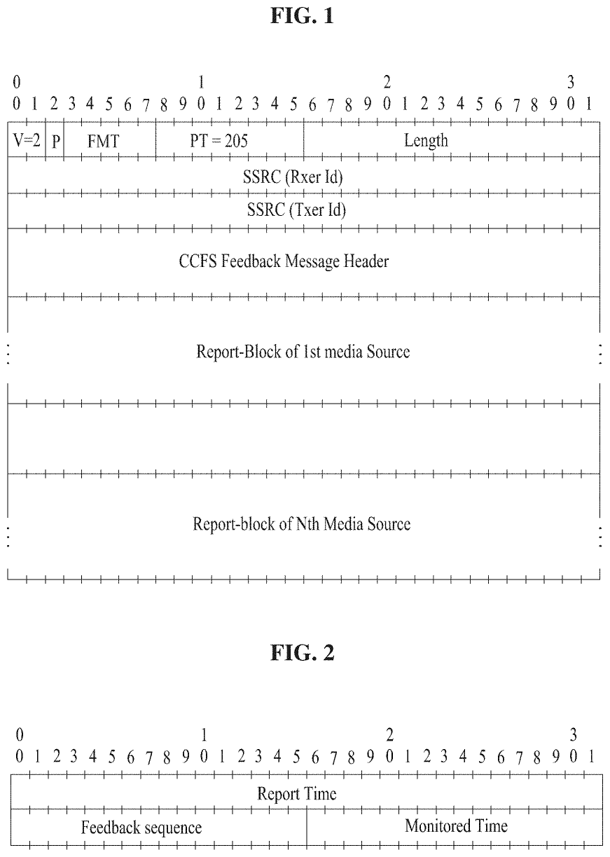

FIG. 1 illustrates a CCFS feedback message format according to some example embodiments.

The first 4 octets are an RTCP header, with PT=205 and FMT=CCFSFB, and next 4 octets are SSRC of a packet sender. The CCFS may replace SSRC with a Rxer ID which may be obtained from the prior negotiation.

The RTCP header may be followed by the SSRC of the media source being reported upon. A Txer ID is located here instead of a specific RTP SSRC because this feedback message may not designate one SSRC.

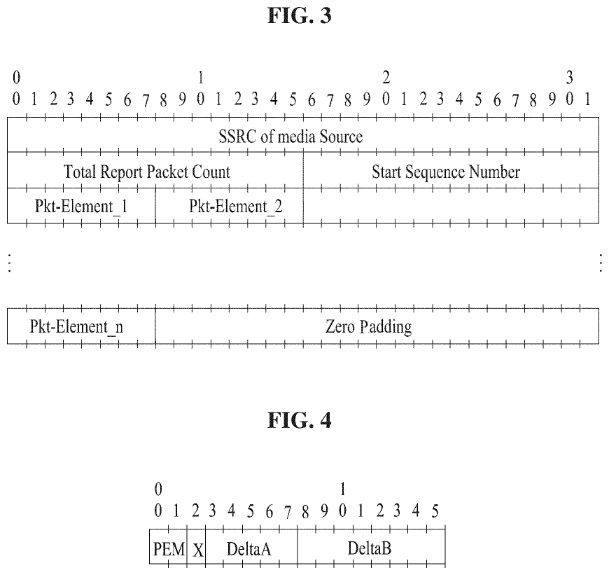

Next 8 octets may be a CCFS feedback message header that is formatted as FIG. 2.

FIG. 2 illustrates a CCFS feedback message header according to some example embodiments.

Each field is described as follow.

Report Time (4 octets): The time instant may be when this feedback message is generated. The value of the report time may be derived from the same wall-clock time used to generate an NTP timestamp field in RTCP SR (Sender Report) packets. It may be formatted as the middle 32 bits of an NTP format timestamp. If the Rxer does not use NTP, it may be replaced with other measures such as system uptime, but the corresponding Txer may be informed. In some example embodiments, the report time may be a value corresponding to system uptime, and may be monochromic increasing time from the system booting. For example, the report time may be 1000 mec.

Feedback Sequence (2 octets): It may indicate the sequence number of the feedback message. The Txer may figure out the packet loss event of the forward path if the reported packet sequence number is not continued even though the feedback sequence is increase by one.

Monitoring time (2 octets): It may indicate an actually observed millisecond duration to generate a feedback message. Normally this is the time by the Txer preferred and equal or bigger than the current feedback interval time. However if the building feedback information causes bigger message size than MTU size, the Rxer may promptly or immediately send the feedback message with the real monitored time. So, the monitored time may be smaller than the current Txer preferred monitor time.

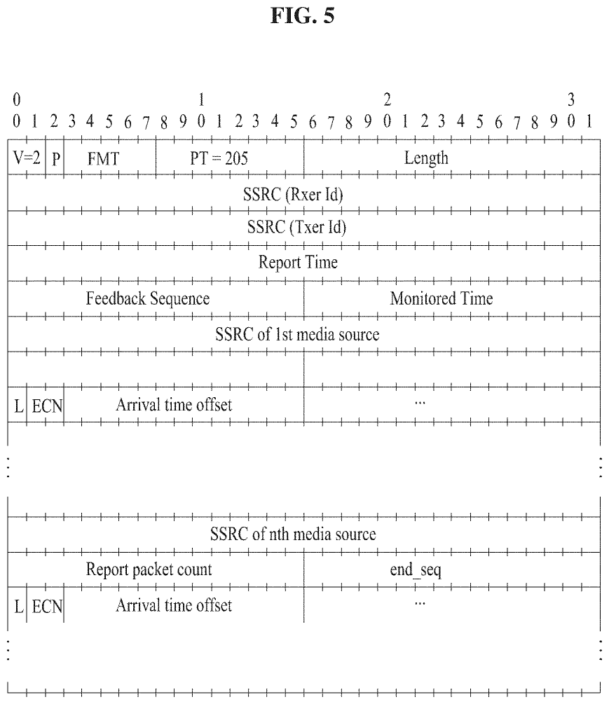

Then, multiple report blocks may be followed. One report block describes received packets from one media source that is identified by SSRC. Report block size is not fixed and the format is as illustrated in FIG. 3.

FIG. 3 illustrates a CCFS feedback report block according to some example embodiments.

Each field will be described below.

SSRC of a Media Source (4 octets): It may indicate RTP SSRC to report.

Total Report Packet Count (2 octets): It may indicate the reporting RTP packet count. If this value is zero, remain fields of this report-block may be ignored.

Start Sequence Number (2 octets): It may start RTP sequence number of reported packets. This is the sequence number of the following first Pkt-elements.

Pkt-Element (1 or 2 octets): It may describe for each packet. The count of Pkt-element is the total report packet count and these are sorted by RTP sequence number order.

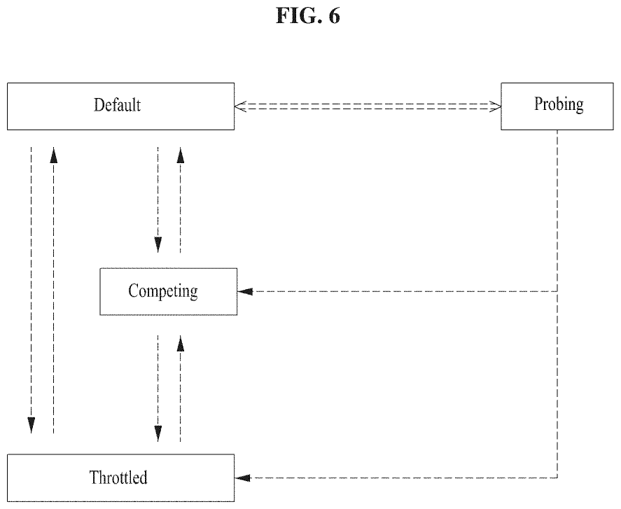

Pkt-Element format may be represented as FIG. 4.

FIG. 4 illustrates a CCFS Pkt-element according to some example embodiments.

Each field is described below.

PEM (2 bits): It may indicate a packet-element mode. The meaning may be defined according to the value, such as the following:

0: It may indicate received packet and not set or unsupported explicit congestion.

1: It may indicate received packet and ECN of an IP header of a RTP packet is 0x3.

2: It may indicate received packet and delta is negative.

3: Not received packet. The size of the Pkt-element with 3PEM is one byte.

X (1bit): It may set if absolute of delta is bigger than 31. If this value is not set, the Pkt-element size may be one byte. If this value is set, the Pkt-element size is two bytes and delta value may be calculated with DeltaB.

Delta (5 or 13 bits): It may indicate packet arrival interval millisecond. If the Pkt-element is the first, the delta is an interval from a monitoring start time. And, the monitoring start time may be the subtracted monitored time from the report time. The delta of remains is the arrival interval time of the RTP packet, as measured between N−1 RTP sequenced packet (hear in after “N−1 RTP”) and N RTP.

Delta consists of two parts—DeltaA and DeltaB. DeltaB may be included only if X bit is set. If DeltaB is not present, the delta value is the DeltaA so the maximum delta value is 31. And, if DeltaB is present, the delta value is represented as 13 bits as (DeltaA<<8)|DeltaB) so the maximum delta value is 8191.

If N RTP arrives before N−1 RTP, the delta of the N RTP may be a negative value. In the case of that, delta represents an absolute value and PEM may be set as 0x2.

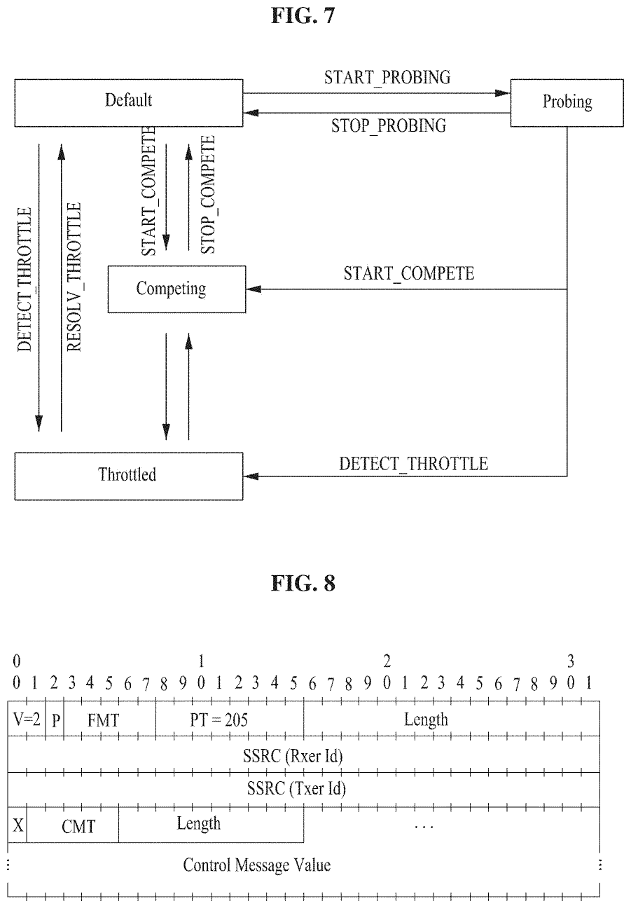

FIG. 5 illustrates another example of a CCFS feedback message format according to some example embodiments.

Since the description for the technical features described above with referring to FIGS. 2 to 4 may be applied for FIG. 5, duplicated description will be omitted.

Each field is described below.

Txer/Rxer ID may be respectively SSRC of a transmitter and a receiver. When it is supposed that path used in packet transmission is one, packet using the same path may be grouped as the same Rxer ID (Txer ID). In other words, the Rxer ID (the Txer ID) may be ID indicating a collection of instances using the same path.

Fields of a report block is described below.

Report time may indicate system uptime.

SSRC of a media source may be a part indicating reporting packet of contents such as audio or video.

Report packet count may indicate a value indicating a reported packet count. For example, it may indicate the number of received packets for monitoring time. End_seq may indicate last sequence number of a reported packet. L may indicate whether packet is lost, for example, 1 may indicate lost and 0 may indicate not lost (received).

For example, if five packets are reported, in the case that the packet corresponding to the fourth packet is lost, report packet count may be 5, and end_seq may be 5. L corresponding to the lost fourth packet may indicate 1, and accordingly, it may be identified that the corresponding packet is lost.

ENC (Explicit Congestion Notification) may be a value that a router takes.

ATO (Arrival Time Offset) may indicate relative time distance of reception time of a reported packet to the report time. In other words, it may indicate time offset (10 msec) for received packet to 990 msec for 1000 msec report time as ATO.

As described above, the feedback message format of FIG. 5 may be different from it of FIG. 3 in the field structure of the report block.

The Rxer may build a feedback message based on recent received RTP packets. One Rxer aggregates multiple RTP streams. And sometimes, due to network condition, many packets may arrive in a short time. These facts may make a CCFS feedback message packet big. If a SSFS feedback message size is bigger than an accepted packet size by MTU, which will cause exception cases. So, CCFS Rxer may consider feedback message size. That is, the CCFS feedback message packet size may be smaller than MTU size.

For example, if the feedback message size approaches an available size by MTU, the Rxer may promptly or immediately send the feedback message. The monitored time value within the feedback message will be shorter than a Txer preferred monitoring time. After sending the instant feedback message, the Rxer may re-start monitoring for the next feedback.

The CCFS feedback message size may be estimated as a first equation:

FBM-Size=20+8R+1.5T [Equation 1]

R may mean an associated RTP stream count. And T may mean a total report packet count. 1.5 may be the assumed average size of Pkt-element and this may not be exact. The constant 1.5 is used for the simplicity of the implementation in Equation 1.

Handling CCFS control messages in the Rxer is described in below.

A CCFS control message may be a type of RTCP (RTP control Protocol) message sent by the Txer. This RTCP message may be defined if the Txer selects or requires such a message, for example, for a specific feature. If the Rxer receives understandable control messages, Rxer may respond accordingly. If not, the received messages may be ignored and discarded.

The Txer is described in more detail below.

The Txer may keep sent RTP packet array (txed_trpts) about RTP streams. The txed_rtps may contain sent local timestamp, packet size, RTP seq_number and SSRC.

The Txer may estimate variable metrics when the feedback message is sent for each time the Txer receives a feedback message. This means that all the estimated metrics are the past of backward one way latency ago but remove the effect of a backward path that is the network path of the feedback message.

The Txer may estimate forward path bandwidth, queue latency, and queue latency from external traffics with the feedback message and txed_rtps in monitored time.

And then, the Txer may decide a forward path status and target transmit rate based on the metrics and the current status. The forward path status has four statuses and described in above. Actually this status may affect the logic of the Txer globally.

Related constants are described below.

The Txer is described using pseudocode rather than code in a programming language or format. As an example, some constants that may be used are listed here.

FwdBwEstWei=0.9

I_FwdBwEstWei=(1.0−FwdBwEstWei)

TargetQDelay=50 msec

WndBrFract=1 sec

TrigProbQDFractMax=0.8

TrigProbBrFractMin=1.0

TrigProbQMRangeMax=10 msec

TrigProbLossRtMax=0.02

TrigProbECNRtMax=0.0

TrigStopProbQDFractMin=1.3

TrigStopProbBrFractMin=1.2

TrigStopProbLossRtMax=0.0

TrigStopProbECNRtMax=0.0

TrigCompQDelayMin=200 msec

TrigCompQMRangeMi=100 msec

TrigStopCompQDelayMax=100 msec

TrigStopCompQMRangeMax=20 msec

TrigThroQDFractMin=1.5

TrigThroBrFractMax=0.9

Thro2CompQIncrTime=1 sec

DfltQDFractLow=0.5

DfltQDFractHi=1.1

DfltBrincrRate=1.01

DfltBrDecrRate=0.95

CompTargetTxbwRate=1.3

ThroTargetTxbwRate=0.5

ProbingTime=4 sec

CompQDFractLow=0.5

CompQDFractHi=1.0

CompBrincrRate=1.02

Monitoring time on the Txer is described below.

Whenever the Txer receives a feedback message, the Txer may calculate the monitored time that is matched with the monitored time on the Rxer. The latest end sequence in the feedback message is the base point of time to find out the monitored time on the Txer.

(latest_end_seq,ssrc)=find_out(fbm)

sent_tstmp_end_seq=get_tstmp(txed_rtps,latest_end_seq,ssrc)

end_tstmp=sent_tstmp_end_seq+fbm.ato(latest_end_seq,ssrc)

bgn_tstmp=period_end_tmstmp−fbm.monitored_time [Algorithm 1]

Referring to the above Algorithm 1, the fbm stands for the feedback message and the tstmp is time stamp of the Txer. First of all, find out the sent local time stamp (sent_tstmp_end_seq) of the latest RTP packet among the reported. And the monitored end time on the Txer sets as the ATO time and sent_tstmp_end_seq.

Forward path bandwidth estimation is described below.

The bandwidth of the forward path is estimated based on received rate on the Rxer. For example, it may be estimated based on a second equation:

fwd_bw=tot_rxed_size/fbm.monitored_time [Equation 2]:

The tot_rxed_size may be sum of sent packet size that is found from txed_rtps with the reported ssrc and seq. If there are the lost packets, they may be excluded. The CCFS updates esti_bw with the fwd_bw using moving average to remove outlier. Unfortunately, the moving average calculation causes time penalty. Moreover, if the estimated value is too small or too large, it may affect esti_bw negatively. So, the CCFS checks its validation to reduce or minimize the noise.

For example, esti_bw update may be performed based on Algorithm 2 below.

[Algorithm 2]

if( status != Throttled &&
(status == Competing && target_bw < fwd_bw && lost == 0) &&
(sent_size > tot_rxed_size)
| | (sent_size == tot_rxed_size && target_bw < fwd_bw) )
esti_bw = FwdBwEstWei*esti_bw + I_FwdBwEstWei*fwd_bw

First of all, the current status may not be throttled status because target bandwidth shrinks during throttled status to empty queue. And if the current status is a competing status, update esti_bw only if it fulfills a certain condition. After status check, sent_size may be larger than tot_rxed_size because it means the sent bitrate is about bottlenecked bandwidth or greater for the period. And if the current target bandwidth is underestimated, it updates esti_bw.

Queue delay estimation and find increase pattern are described below.

To estimate a queue delay of a forward path, a received timestamp may be calculated for each packet using ATO field in the feedback message. The queue delay may be selected as the minimum queue delay among the estimated queue delays of the reported packets.

The queue delay may not be exact but its relative values and pattern may be used as an important signal. The CCFS may find out increasing pattern and its duration as below Algorithm 3.

[Algorithm 3]

```
if( last_qdelay < qdelay )
    incr_count++
    if(incr_count == 1)
      incr_start_tstmp = end_tstmp
    incr_duration = end_tstmp − incr_start_tstmp;
    if(incr_count >= 3 && duration >= IncrMinDuration)
      is_increasing = true
  else
    incr_count = 0
    incr_start_tstmp = 0
    is_increasing = false
  last_qdelay = qdelay
```

Above Algorithm 3 may be replaced by others if it shows good performance.

Handle by status is described below.

Transmit rate (target_txbw) may be updated based on the calculated parameters based on a third equation:

qd_fract=qdelay/target_qdelay; br_fract=recved_size_wnd/sent_size_wnd [Equation 3]:

Above Equation 3 may represent a method for calculating parameter used to check status and control transmit rate.

Above two fractions are used directly check (forward path) status and control transmit rate. The received_size_wind means that total received packet size for the last window time (WndBrFract) and the sent_size_wind is the total sent packet size for the same time.

Before controlling transmit rate, a specific condition may change a status, and CCFS may define the condition as control event. Control event list and conditions are described in Table 1.

TABLE 1

| Control Event | Conditions |
|---|---|
| CTRL_NOTHING | * default value |
| CTRL_START_COMPETE | 1. qdelay > TrigCompQDelayMin && |
| | qmrange > TrigCompQMRangeMin |
| | 2. Throttled status |
| | && incr_duration > |
| | Thro2CompQIncrTime |
| CTRL_START_PROBING | status is not Probing&& is_increasing == |
| | false |
| | && qd_fract < TrigProbQDFractMax |
| | && br_fract >= TrigProbBrFractMin |
| | && qmrange < TrigProbQMRangeMax |
| | && ecn_rate < TrigProbECNRtMax |
| | && loss_rate < TrigProbLossRtMax |
| CTRL_DETECT_THROTTLE | is_increasing && qd_fract > |
| | QDFractMinTrigThro |
| | && br_fract < BrFractMaxTrigThro |
| CTRL_STOP_COMPETE | Competing status&& comp_duration > |
| | CompMaintainTime |
| | && qdelay < QDelayMaxTrigCompStop |
| | && qmrange < QMRangeTrigCompStop |
| CTRL_STOP_PROBING | 1. Probing status && is_increasing |
| | 2. Probing status |
| | && qd_fract > TrigStopProbQDFractMin |
| | 3. Probing status |
| | && br_fract > TrigStopProbBrFractMin |
| | 4. Probing status |
| | && ecn_rate >= TrigStopProbECNRtMax |
| | 5. Probing status |
| | && loss_rate >= TrigStopProbLossRtMax |
| CTRL_RESOLV_THROTTLE | Throttled status && qdFract < 1.0 |

Handle control event by status is described below. CTRL_START_COMPETE and CTRL_DETECT_THROTTLE may be important signals to react promptly irrespective of the status of the forward path. So, extracted handlers may be described as below Algorithm 2, for example.

[Algorithm 4]

```
do_start_compete( ):
    target_qdelay = TargetQDelay + TargetXQDelay
    target_txbw = esti_bw * CompTargetTxbwRate
    status = Competing
  return
  do_detect_throttle( ):
    thro_backup_target_txbw = esti_bw
    target_txbw = esti_bw * ThroTargetTxbwRate
    status = Throttled
  return
```

Comprehensive handling for each status may be complicated. So, the present disclosure supplements the pseudocode with a simple available status change diagram such as FIG. 6.

FIG. 6 illustrates a status change diagram for statuses according to some example embodiments.

The below Algorithms 5 to 8 describe a process for control event for each status.

[Algorithm 5]

```
<Default status>
  Event: CTRL_NOTHING
      if(qd_fract < DfltQDFractLow && target_txbw < esti_bw)
        target_txbw *= DfltBrIncrRate
      else if(qd_fract > DfltQDFractHi)
        target_txbw *= DfltBrDecrRate
    Event: CTRL_START_PROBING
      prob_backup_target_txrt = esti_bw
      target_txbw = esti_bw + prob_bw
      prob_start_tstmp = curr_tstmp
      status = Probing
    Event: CTRL_START_COMPETE
      do_start_compete( )
    Event: CTRL_DETECT_THROTTLE
      do_detect_throttle( )
```

[Algorithm 6]

```
<Competing status>
  Event: CTRL_NOTHING
      if( qd_fract < CompQDFractLow | | qd_fract < CompQDFractHi )
          target_txrt *= CompBrIncrRate
    Event: CTRL_SOTP_COMPETE
        target_qdelay = TargetQDelay
        status = Default
    Event: CTRL_DETECT_THROTTLE
        do_detect_throttle( )
```

[Algorithm 7]

```
<Probing status>
  Event: CTRL_NOTHING
      if(curr_tstmp − prob_start_tstmp > ProbingTime)
          status = Default
          target_txnw = prob_backup_target_txbw + prob_bw
    Event: CTRL_STOP_PROBING
      target_txbw = esti_bw
      status = Default
    Event: CTRL_START_COMPETE
        do_start_compete( )
    Event: CTRL_DETECT_THROTTLE
        do_detect_throttle( )
```

[Algorithm 8]

```
<Throttled status>
  Event: CTRL_RESOLV_THROTTLE
        target_txbw = thro_backup_target_txbw
        status = Default
    Event: CTRL_START_COMPETE
        do_start_compete( )
    Event: CTRL_DETECT_THROTTLE
        thro_backup_target_txbw = esti_bw
      target_bcbw = esti_bw * ThroTargetTxbwRate
```

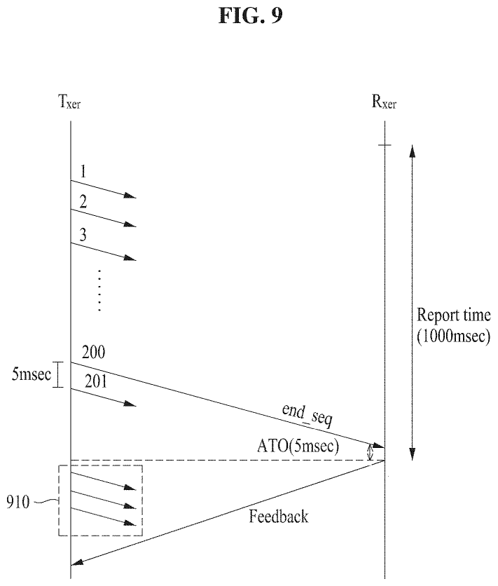

FIG. 7 illustrates a status change diagram for statuses according to some example embodiments.

For example, in the case that the forward path status is default status, if queue delay lasts for a predefined time at a relative low value, the forward path status may be defined as probing status. Here, QMrange may be low. Since the probing status indicates that net status is good (e.g., all transmitted packet is received), target transmit rate for the forward path may be determined to be higher, and accordingly, transmit rate may be controlled.

In the case that queue delay lasts for a predefined time at a relative high value in probing status or default status, the forward path status may be defined as competing status. To prevent or reduce starvation in competing status, target transmit rate may be defined as moderately low value (e.g., 70% of limited transmit rate), and accordingly, transmit rate may be controlled.

If queue delay increases at a rate above a second threshold (e.g., abruptly) and transmitting bandwidth decreases in probing status, the forward path status may be defined as throttled status. Here, QMrange may be high. In throttled status, target transmit rate may be defined as considerably low value (e.g., below 50% of limited transmit rate), and accordingly, transmit rate may be controlled.

Since the description for the technical features described above with referring to FIGS. 1 to 6 may be applied to FIG. 7, duplicated description will be omitted.

Processing operation for CCFS control messages in the Txer is described below.

If the Txer wants to implement a specific feature with the help of the Rxer, it may send CCFS control messages. The CCFS control message may be a RTP message with FMT=CCFSCRTL value.

FIG. 8 illustrates a control message format according to some example embodiments.

Each field is described below.

SSRC for a media source may be replaced with a Rxer Id.

A control message block is followed, and it may be multiple. The X bit may indicate there is a control message block following the current block.

A CMT may be the control message type to inform the Rxer in which a control message value type may be used. If the Rxer does not understand the CMT, it may discard the message.

A length may be the octet size of the control message value.

A control message value may be different depending on the CMT value.

Update preferred feedback interval and monitoring time in the Txer is described below.

The Txer may change the feedback interval. This message may not be guaranteed, so the Rxer may not send a respond message.

The following represents an example of the interval time change.

CMT: 1

Length: 2

Also, the Txer may change the monitoring time. This message may not be guaranteed, so the Rxer may not send response message but applied feedback message may have the updated monitored field value.

The following represents an example of the monitoring time change.

CMT: 2

Length: 2

Control Message Value: Monitoring time (msec)

Congestion control technology of CCFS in some example embodiments may have an advantage over the existing congestion control technology as follows.

CC (Congestion Control) of TCP aims not to shortly maintain latency as congestion control in TCP stack but to avoid loss by reducing traffic if loss is existed in network. CC of TCP does not consider low latency, but the CCFS in some example embodiments may consider this.

Also, the CCFS has an advantage to use the existing RTP receiver as it is in performing receiver-driven congestion control similar to NADA and SCReAM corresponding to CC algorithms in RMCAT. Also, in the CCFS of some example embodiments, compared to GCC, NADA, and SCReAM, since it does not perform congestion control using shaping buffer, problems related to service latency at application level are not occurred. Also, unlike GCC, since the CCFS of some example embodiments does not perform bit drop or padding for data generated from codec, it may efficiently use network resources.

Also, in the CCFS of some example embodiments, by independently considering congestion of forward path and backward path of RTP stream, it may indicate prominent performance in comparison with the above existing technologies.

Therefore, the CCFS of some example embodiments may solve a problem that an algorithm itself for congestion control is weak to impairment of a backward path receiving feedback, not a forward path.

For example, in the CCFS of some example embodiments, calculation time may be not feedback message receiving time (on Tx node) but feedback message transmitting time (by RX node) in that the Txer or Tx node estimates a network status by receiving feedback message of Rxer or Rx node. Through this, misjudgment for impairment (e.g., loss, congestion, and the like) of the backward path in which the feedback message is received may be removed.

A method for transmitting a packet and a feedback packet message between a transmitter and a receiver will be described in detail with referring to FIG. 9.

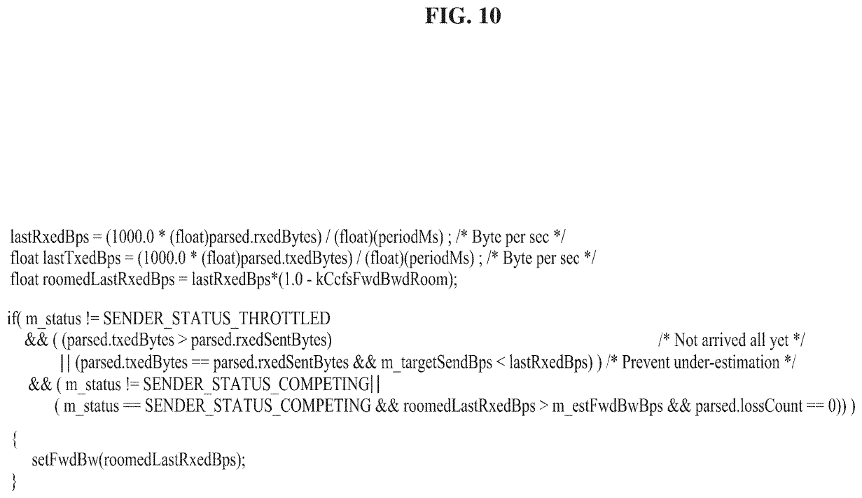

The below FIGS. 10 to 13 represents example algorithms related to some example embodiments, such as described above. Algorithms described with referring to the present disclosure and some figures may represent pseudocode rather than code in a programming language or format.

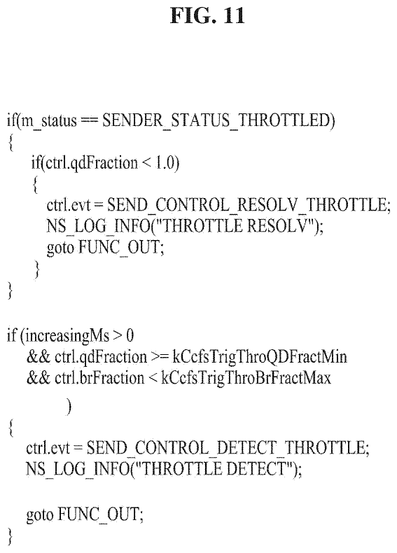

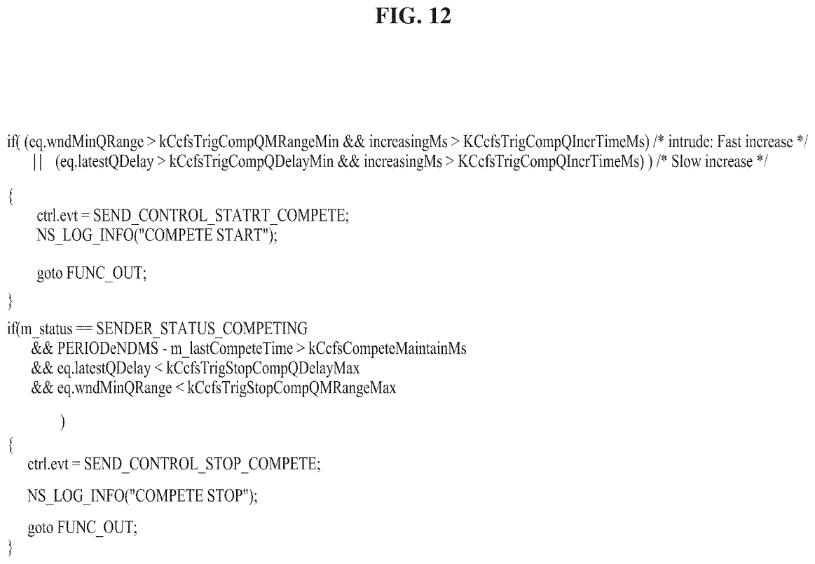

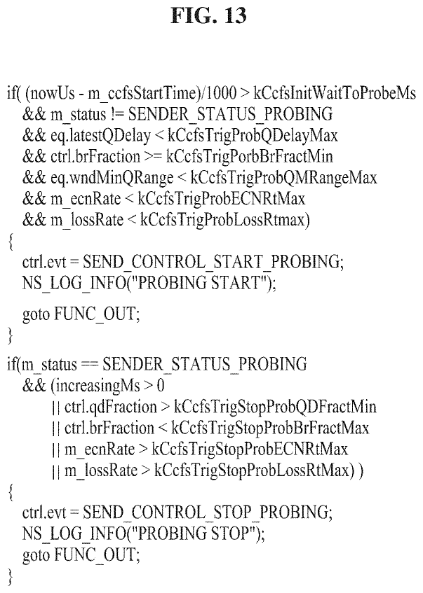

FIG. 10 is an algorithm illustrating a method for estimating FwdBW according to some example embodiments. For example, FIG. 10 may represent an algorithm determining bottlenecked bandwidth of a forward path. FIG. 11 is an algorithm illustrating a method for processing an event related to throttled status according to some example embodiments. FIG. 12 is an algorithm illustrating a method for processing an event related to competing status according to some example embodiments. FIG. 13 is an algorithm illustrating a method for processing an event related to probing status according to some example embodiments.

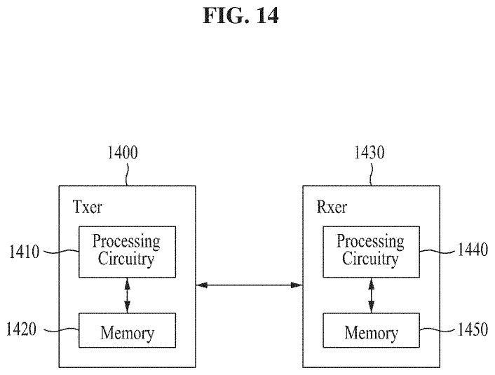

FIG. 14 is a block diagram illustrating an internal configuration of a transmitter and a receiver according to some example embodiments.

An illustrated Txer 1400 may be Tx node configured to transmit a packet (traffic) to a Rxer 1430 through a forward path. The Rxer 1430 may be Rx node configured to generate a feedback message for reporting the received packet for the received packet and transmitting the feedback message to the Txer 1400 through a backward path. The Rxer 1430 may be configured to periodically transmit the feedback message to the Txer 1400. The Txer 1400 may be configured to update a forward path bandwidth and a forward path status each time it receives the feedback message from the Rxer 1430, for example. The forward path status may be any one of throttled status, competing status, probing status, and default status as described above. The Txer 1400 may be configured to determine target transmit rate for the forward path based on the metric and the forward path status, including the bandwidth, and to control the transmit rate of the forward path.

In other words, a method for determining target transmit rate according to some example embodiments may be implemented through the Txer 1400. Also, a method for enabling a receiver to transmit a feedback message to a transmitter according to some example embodiments may be implemented through the Rxer 1430.

The Txer 1400 may include processing circuitry 1410 and a memory 1420. The Txer 1400 may consist of one or more computer systems. The Txer 1400 may further include components such as an antenna for transmitting and receiving data like a packet. In some example embodiments, the processing circuitry 1410 may include hardware such as logic circuits; a hardware/software combination, such as a processor executing software; or a combination thereof. For example, a processor may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry 1410 may include any device which may process sequence of commands or a part thereof as the component for implementing the method for determining target transmit rate of some example embodiments. The processing circuitry 1410 may include, for example, a processor in a transport unit or another electronic device and/or a digital processor. The processing circuitry 1410, for example, may be included in a server computing device, a sever computer, a series of server computers, a sever farm, a cloud computer, a content platform, and the like. The processing circuitry 1410 may be connected to the memory 1420 through a bus (not illustrated), for example.

The memory 1420 may include a volatile memory, a persistent, a virtual or another memory for storing information used or outputted by the Txer 1400.

The memory 1420 may include, for example, a RAM (Random Access Memory) and/or a DRAM (dynamic RAM). The memory 1420 may be used to store any information such as the Txer 1400 status information. The memory 1420 may be also used to store commands of the Txer 1400 including commands for performing the method for determining target transmit rate of some example embodiments. The Txer 1400 may include processing circuitry 1410.

For the Rxer 1430 and processing circuitry 1440 and a memory 1450 of the Rxer 1430, since a description similar to the description for the Txer 1400 and the processing circuitry 1410 and the memory 1420 of the Txer 1400 may be applied, duplicated description is omitted.

In other words, in some example embodiments, the Rxer 1430 may include the processing circuitry 1440 and the memory 1450 as components for executing the method for enabling the Rxer 1430 to transmit a feedback message to the Txer 1400 of some example embodiments. Or, in some example embodiments, the Txer 1400 and the Rxer 1430 may be implemented identically, and according to transmitting and receiving a packet between them, the Txer 1400 (or the Rxer 1430) may operate as both of the transmitter and the receiver. The processing circuitry 1440 of the Rxer 1430 may include a variety of hardware, in a similar manner as the processing circuitry 1410 of the Txer 1400.

Since the description for the technical features described above with referring to FIGS. 1 to 13 may be applied to FIG. 14, duplicated description is omitted.

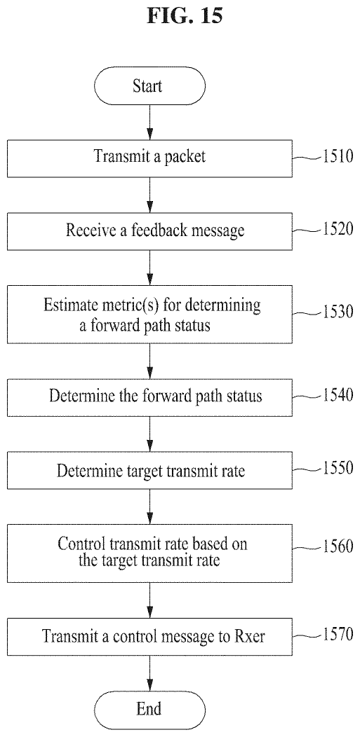

FIG. 15 is a flow chart illustrating a method for determining target transmit rate according to some example embodiments. It is to be appreciated that illustrated methods such as FIG. 15 represent only some example embodiments, and that other example embodiments may include variations of such methods. For example, in some example embodiments, operations may be reversed or reordered as compared with illustrations such as FIG. 15. Some operations may be omitted and/or duplicated, such as performing operations repeatedly or iteratively. Some operations may be performed conditionally, such as based on a test. Some operations may be combined with other operations, or distributed into two or more operations; and some operations may occur before, after, and/or wholly or partly concurrently with other operations. All such example embodiments that are not inconsistent with the specification are intended to be included in the present disclosure.

Referring to FIG. 15, it is described for a method for determining target transmit rate for a forward path for packet transmission to the Rxer 1430 performed from the Txer 1400. An operation performed by configuration(s) of the Txer 1400 is described as being performed by the Txer 1400 for convenience of explanation. The same is true of the Rxer 1430.

In Operation 1510, the Txer 1400 may be configured to transmit a packet to the Rxer 1430 through a forward path.

In Operation 1520, the Txer 1400 may be configured to receive a feedback message including information for the packet received from the Txer 1400, from the Rxer 1430.

In Operation 1530, the Txer 1400 may be configured to estimate at least one metric for determining a forward path status based on the feedback message. The metric may reflect characteristics associated with the forward path from which influence by a backward path which is a path that the feedback message is transmitted is removed. For example, the Txer 1400 may be configured to estimate metric including a forward path bandwidth (e.g., bottlenecked bandwidth) and queue delay. Also, the Txer 1400 may be further configured to estimate a metric corresponding to a queue delay range (e.g., QMrange).

In Operation 1540, the Txer 1400 may be configured to determine a forward path status based on the metric. The status of the may be one of throttled status, probing status, competing status, and default status. For example, determining forward path status may be performed by using machine learning.

In Operation 1550, the Txer 1400 may be configured to determine target transmit rate for the forward path based on the status of the forward path.

In Operation 1560, the Txer 1400 may be configured to control transmit rate of the packet to the Rxer 1430 of the Txer 1400 at the target transmit rate.

If the status of the forward path status is a throttled status or a default status, the Txer 1400 may be configured to determine target transmit rate to empty the queue by lowering transmit rate of the packet to the Rxer 1430 of the Txer 1400, and accordingly, transmit rate of the forward path may be controlled.

Or, if the status of the forward path is a competing status or a default status, the Txer 1400 may be configured to determine target transmit rate to maintain queue latency below a target queue latency, and accordingly, transmit rate of the forward path may be controlled.

Or, if the status of the forward path is a probing status, the Txer 1400 may be configured to determine target transmit rate to increase transmit rate of the packet to the Rxer 1430 of the Txer 1400 to determine bottlenecked bandwidth of the forward path, and accordingly, the transmit rate of the forward path may be controlled. The bottleneck bandwidth may correspond to available bandwidth of the forward path or bandwidth limitation of the forward path.

In Operation 1570, the Txer 1400 may be configured to transmit a control message to request a specific feature to the Rxer 1430. If the control message has a type of message that the Rxer 1400 may understand, a response for the control message may be received from the Rxer 1430. In some example embodiments and unlike illustrated, Operation 1570 may be performed before Operation 1510.

Describing the forward path status in more detail, throttled status may indicate a status in which transmit rate of the packet to the Rxer 1430 of the Txer 1400 is larger than bandwidth limitation of the forward path. In other words, a throttled status may indicate a status in which a queue is filling up. A competing status may indicate a status in which cross traffics are detected. A probing status may indicates a status in which transmit rate of the packet to the Rxer 1430 of the Txer 1400 is below the bandwidth limitation. In other words, the probing status may correspond to a case that the bottlenecked bandwidth of the forward path is larger than the estimated bandwidth. The default status may indicate the forward path status which does not belong to above 3 statuses.

As described with referring to FIG. 7, when the estimated queue delay lasts for a first time at a relatively low value (e.g., an identifiable, desired, and/or predetermined first value), the forward path status may be determined as probing status. Or, when queue delay lasts for a second time at a relatively high value (e.g., an identifiable, desired, and/or predetermined second value), the forward path status may be determined as competing status. When it is estimated that queue delay increases at a rate above a second threshold (for example, abruptly), and/or that QMrange increases at a rate above the second threshold (for example, abruptly) and the forward path bandwidth decreases, the forward path status may be determined throttled status.

In Operation 1520, the feedback message may be periodically received. For example, the feedback message may be received every interval time (e.g., an identifiable, desired, and/or predetermined time interval, such as the above described interval time). The Txer 1400 may be configured to estimate metric including bandwidth whenever the feedback message is received. The feedback interval time may be set from the Txer 1400. Monitored time corresponding to an observed duration in generating the feedback message also may be set from Txer 1400. The monitored time may be set to be greater than or equal to the feedback interval time.

Target transmit rate may be determined based on the below Equations 4 to 7, for example. As an example, if the status of the forward path is a competing status, the target transmit rate may be determined according to target bandwidth determined according to a fourth equation.

Target bandwidth(targetbr)=estimated forward path bandwidth(forwadbw)*N % [Equation 4]:

N may be, for example, a real number greater than 50 less than 100.

If the status of the forward path is a throttled status, the target transmit rate may be determined according to the target bandwidth determined according to a fifth equation.

Target bandwidth(targetbr)=estimated forward path band width(forwardbw)*0.5 [Equation 5]:

If the status of the forward path is a probing status, the target transmit rate may be determined according to the target bandwidth determined according to a sixth equation.

Target bandwidth(targetbr)=Estimated forward path bandwidth(forwardbw)*(1+alpha), wherein Alpha may be a real number greater than 0. [Equation 6]:

If the status of the forward path is a default status, the target transmit rate may be determined according to target bandwidth corresponding to the bandwidth of the forward path (referring to a seventh equation).

Target bandwidth(targetbr)=Estimated forward path bandwidth(forwardbw) [Equation 7]:

As above described with referring to FIG. 1, the feedback message may include a report block including data for a RTCP header, a Rxer ID, a Txer ID, a feedback message header, and a reported packet.

As above described with referring to FIGS. 2 and 3, the feedback message header may include a report time field, a feedback sequence field, and a monitored time field. The report time field may include a value indicating system uptime as report time, the feedback sequence field may include a value indicating sequence number of feedback sequence, and monitored time field may include a value indicating an observed duration for generating feedback message as monitored time.

As above described with referring to FIG. 4, the report block may include an SSRC field including a value indicating SSRC of reported packet, a reported packet count field including a value indicating count of reported packet, a start sequence number field including a value indicating start sequence number of reported packet, and a Pkt-Element field including a value indicating information for each reported packet.

Or, as above described with referring to FIG. 5, the reported block may include an SSRC field including a value indicating SSRC of reported packet, a reported packet count field including a value indicating a value indicating count of reported packet, an end_seq field including a value indicating last sequence number of reported packet, a L field including a value indicating whether packet is lost, and an ATO (Arrival Time Offset) including a relative time distance of reception time of reported packet to the report time.

The Txer 1400 may be configured not to consider (e.g., to disregard) a packet transmitted from the Txer 1400 before receiving the feedback message after transmitting the packet corresponding to the end_seq field value in estimating metric for determining the forward path status, based on the reported time of the feedback message and the end_seq field value. For example, referring to FIG. 9, packets 910 transmitted to the Rxer 1430 from the Txer 1400 after transmitting a feedback message may not be considered in estimating metric for determining a forward path status. In other words, implied packets transmitted after transmitting a feedback message such as the packets may not be used in determining the forward path status.

Therefore, the metric estimated by the Txer 1400 may reflect characteristics associated with the forward path from which influence by a backward path which is a path that the feedback message is transmitted is removed. In some example embodiments, metric is estimated based on the time when the feedback message is transmitted from the Rxer 1430, not the time when the feedback message is received from the Txer 1400.

The Txer 1400 may be configured to consider the packet transmitted from the Txer 1400 for time corresponding to the ATO field value of the packet corresponding to the end_seq field value after transmitting the packet corresponding to the end_seq field value in estimating metric for determining the forward path status. For example, describing with referring to FIG. 9, when the packet corresponding to the end_seq of the feedback message is a packet 200 and ATO of the packet 200 is 5 msec, a packet 201 may be transmitted to the Rxer 1430 within 5 msec after the packet 200 is transmitted to the Txer 1400. The packet 201 may be considered in calculating target transmit rate for the forward path of the Txer 1400. Therefore, it may be possible to determine the forward path status and target transmit rate for the forward path more accurately.

Since the description for the technical features described above with referring to FIGS. 1 to 14 may be applied to FIG. 15, duplicated description is omitted.

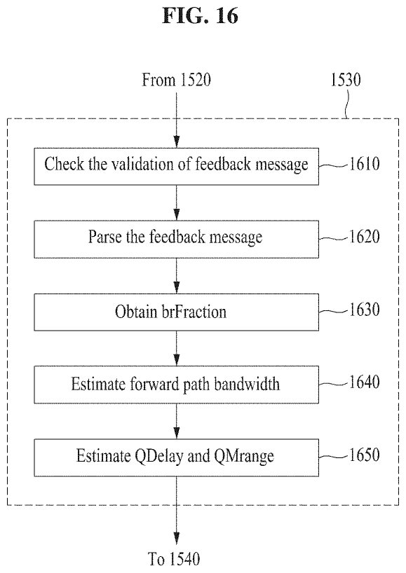

FIG. 16 is a flow chart illustrating a method for estimating metric for determining a status of a forward path according to some example embodiments.

The Operation 1530 described above with referring to FIG. 15 may further include the following described Operation 1610 to 1650.

In Operation 1610, the Txer 1400 may be configured to check validation of a received feedback message. For example, the Txer 1400 may be configured to check a feedback message field such as sequence number and the like.

In Operation 1620, the Txer 1400 may be configured to parse the feedback message.

In Operation 1630, the Txer 1400 may be configured to obtain bitrate fraction (brFraction) corresponding to ratio of a size of the packet received by the Rxer to a size of the packet transmitted by the Txer 1400, based on data included in the feedback message (e.g., data included in the field). The brFraction may be calculated based on Rxbitrat/Txbitrate (e.g., received packet bite/transmitted packet bite).

In Operation 1640, the Txer 1400 may be configured to estimate the bandwidth of the forward path based on the obtained brFraction. The estimated bandwidth of the forward path may be the bottlenecked bandwidth of the forward path.

In Operation 1650, the Txer 1400 may be configured to estimate QMrange corresponding to QDelay and QDelay range for the forward path. The QDelay, for example, may be estimated by using LEDBAT. QMrange, for example, may be estimated by minimum subtraction.

The Txer 1400 may be configured to determine the forward path status based on at least one of defined event for determining the forward path status, the estimated bandwidth of the forward path, QDelay or QMrange, and accordingly, target transmit rate may be determined.

Since the description for the technical features above described with referring to FIGS. 1 to 15 may be applied to FIG. 16, duplicated description is omitted.

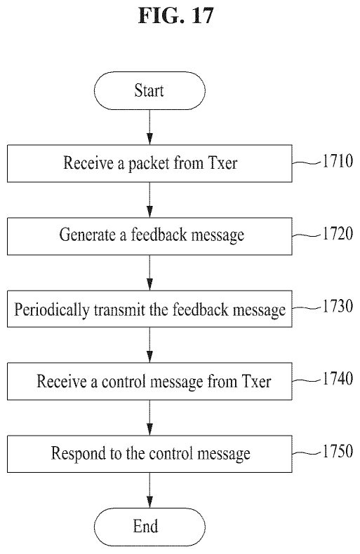

FIG. 17 is a flow chart illustrating a method for enabling a receiver to transmit a feedback message to a transmitter according to some example embodiments.

Referring to FIG. 17, a method that the Rxer 1430 generates and transmits a feedback to the Txer 1400 is described.

In Operation 1710, the Rxer 1430 may be configured to receive a packet from the Txer 1400.

In Operation 1720, the Rxer 1430 may be configured to generate a feedback message including information for the packet previously transmitted by the Txer 1400 for a monitored time (which may be identifiable, desired, and/or predetermined). Duplicated description for a feedback message format is omitted.

In Operation 1730, the feedback message may be periodically transmitted to the Txer 1400 according to an interval time (which may be identifiable, desired, and/or predetermined).

In Operation 1740, the Rxer 1430 may be configured to receive a control message for requesting a specific feature to the Rxer 1430 from the Txer 1400.

In Operation 1750, the Rxer 1430 may be configured to respond to the control message if the received control message has a type of message that the Rxer 1430 may be configured to understand. If the control message is not a type of message that the Rxer is configured to understand, the Rxer 1430 may be configured to ignore or discard the received control message. In some example embodiments and unlike illustrated, Operations 1740 and 1750 may be performed before Operation 1710.

When a size of the feedback message approaches an available size by MTU (Maximum Transmission Unit) (for example, the feedback message size is predicted to be larger than an available size by MTU or approaches a size, which may be identifiable, desired, and/or predetermined), the Rxer 1430 may be configured to transmit the feedback message to the Txer 1400 before the corresponding monitored time elapses.

The Rxer 1430 may be configured to start monitoring for generating the next feedback message after transmitting the feedback message.

In other words, the Rxer 1430 may be configured to transmit the feedback message to the Txer 1400 at the feedback message size even before the next feedback interval time reaches.

Since the description for the technical features above described with referring to FIGS. 1 to 16 may be applied to FIG. 17, duplicated description is omitted.

The units described herein may be implemented using hardware components, software components, and/or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In some example embodiments, the software and data may be stored by one or more computer readable recording mediums.

Some example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

While some example embodiments and implementations have been described herein, other embodiments and modifications may be apparent from this description. Accordingly, the disclosure is not limited to the example embodiments discussed herein, but rather to the broader scope of the presented claims and various modifications and arrangements.

What is claimed is:

1. A method of enabling a transmitter to communicate with a receiver based on a target transmit rate for a forward path for packet transmission to the receiver, the method comprising:
receiving, from the receiver, a feedback message including information on a packet previously transmitted by the transmitter;
estimating a metric for determining a status of the forward path based on the feedback message;
determining the status of the forward path based on the metric, determining the target transmit rate for the forward path based on the status of the forward path, and
controlling a transmit rate by the transmitter of the packet to the receiver based on the target transmit rate,
wherein the metric reflects characteristics associated with the forward path from which influence by a backward path which is a path that the feedback message is transmitted is removed.

2. The method of claim 1,
wherein the status of the forward path is one of a throttled status, a probing status, a competing status, and a default status, and
wherein determining the target transmit rate includes,
emptying a queue by lowering the transmit rate by the transmitter of the packet to the receiver based on the status of the forward path being the throttled status,
keeping a queue latency below a target queue latency based on the status of the forward path being the competing status or the default status, and
increasing the transmit rate by the transmitter of the packet to the receiver to determine a bottlenecked bandwidth of the forward path based on the status of the forward path being the probing status.

3. The method of claim 2,
wherein the throttled status indicates that the transmit rate by the transmitter of the packet to the receiver is larger than a bandwidth limitation of the forward path,
wherein the competing status indicates that cross traffics are detected,
wherein the probing status indicates that the transmit rate by the transmitter of the packet to the receiver is below the bandwidth limitation, and
wherein the default status indicates that the forwarding path which is neither the throttled status, the probing status, nor the competing status.

4. The method of claim 1, wherein estimating the metric includes estimating a bandwidth of the forward path and a queue delay.

5. The method of claim 2,
wherein the feedback message is periodically received,
wherein estimating the metric includes estimating bandwidth of the forward path and queue delay,
wherein the status of the forward path is determined as the probing status in response that the queue delay lasts for a first time that is below a first threshold,
wherein the status of the forward path is determined as the competing status in response that the queue delay lasts for a second time that is above the first threshold, and
wherein the status of the forward path is determined as the throttled status in response that the queue delay increases at a rate that is above a second threshold and the bandwidth of the forward path decreases.

6. The method of claim 2,
wherein the feedback message is periodically received,
wherein the metric is based on a bandwidth of the forward path, and
wherein the determining the target transmit rate includes,
in response that the status of the forward path is the competing status, determining the target transmit rate based on a target bandwidth determined by a first equation,
target bandwidth=estimated bandwidth of the forward path*N %, wherein N is a real number greater than 50 and less than 100,
in response that the status of the forward path is the throttled status, determining the target transmit rate based on the target bandwidth determined by a second equation,
target bandwidth=estimated bandwidth of the forward path*0.5,
in response that the status of the forward path is the probing status, determining the target transmit rate based on the target bandwidth determined by a third equation,
target bandwidth=estimated bandwidth of the forward path*(1+alpha), wherein alpha is a real number greater than 0, and
in response that the status of the forward path is the default status, determining the target transmit rate based on the target bandwidth corresponding to an estimated bandwidth of the forward path.

7. The method of claim 1,
wherein estimating the metric includes,
checking validation of the feedback message;
parsing the feedback message;
obtaining brFraction (bitrate Fraction) corresponding to ratio of a size of the packet received by the receiver to a size of the packet transmitted by the transmitter, based on data included in the feedback message;
estimating bandwidth of the forward path based on the brFraction, and
estimating Qdelay (queue delay) and QMrange (queue delay range) for the forward path, and
wherein determining the status of the forward path is based on an event defined for determining the status of the forward path, the bandwidth of the forward path, the Qdelay, and/or the QMrange.

8. The method of claim 1, wherein the feedback message includes a report block including a RTCP header, a Rxer ID, a Txer ID, a feedback message header, and data for a reported packet.

9. The method of claim 8, wherein the feedback message header includes a report time field, a feedback sequence field, and a monitored time field,
the report time field includes a value indicating system uptime of the transmitter as a report time,
the feedback sequence field includes a value indicating sequence number of a feedback sequence, and
the monitored time field includes a value indicating a duration observed to generate the feedback message as a monitored time.

10. The method of claim 8, wherein the report block includes an SSRC field including a value indicating SSRC of the reported packet, a report packet count field including a value indicating count of the reported packet, an end-seq (end sequence) field including a value indicating last sequence number of the reported packet, a L field including a value indicating whether packet is lost, and an ATO (Arrival Time Offset) field including a value indicating a relative time distance of reception time of the reported packet to a report time.

11. The method of claim 8, wherein the report block includes an SSRC field including a value indicating SSRC of the reported packet, a report packet count field including a value indicating count of the reported packet, a start sequence number field including a value indicating start sequence number of the reported packet, and a Pkt-Element field including a value indicating information for each reported packet.

12. The method of claim 10, wherein, based on the report time and the value of the end-seq field, a packet transmitted from the transmitter before receiving the feedback message after a transmission of a packet corresponding to the value of the end-seq field is not considered in the estimating the metric.

13. The method of claim 10, wherein a packet transmitted from the transmitter during time corresponding to a value of an ATO field of a packet corresponding to the value of the end-seq field after a transmission of the packet corresponding to the value or the end-seq field is considered in the estimating the metric.

14. The method of claim 1, wherein the metric is estimated and the status of the forward path is determined based on time when the receiver transmits the feedback message.

15. The method of claim 1, further comprising:
transmitting a control message for requesting a specific feature to the receiver, and
receiving a response from the receiver in response that the control message has a message type that the receiver is able to understand.

16. The method of claim 1,
wherein the feedback message is periodically received based on a feedback interval time,
wherein the feedback interval time is set from the transmitter,
wherein a monitored time as a duration observed to generate the feedback message is set from the transmitter, and
wherein the monitored time is greater than or equal to the feedback interval time.

17. A method for enabling a receiver to transmit a feedback message to a transmitter, the method comprising:
receiving a packet from the transmitter;
generating the feedback message including information on the packet previously transmitted by the transmitter for a monitored time; and
periodically transmitting the feedback message to the transmitter based on a feedback interval time, and
wherein the feedback message includes a report block including a RTCP header, a Rxer ID, a Txer ID, a feedback message header, and data for a reported packet,
wherein the feedback message header includes a report time field, a feedback sequence field, and a monitored time field,
wherein the report time field includes a value indicating system uptime of the transmitter as a report time,
wherein the feedback sequence field includes a value indicating a sequence number of a feedback sequence,
wherein the monitored time field includes a value indicating the monitored time, and
wherein the report block includes an SSRC field including a value indicating SSRC of the reported packet, a report packet count field including a value indicating count of the reported packet, an end-seq (end sequence) field including a value indicating last sequence number of the reported packet, a L field including a value indicating whether a packet is lost, and an ATO (Arrival Time Offset) field including a value indicating a relative time distance of reception time of the reported packet to the report time.

18. The method of claim 17,
wherein based on a size of the feedback message approaching an available size by MTU (Maximum Transmission Unit) before the monitored time elapses, the feedback message is transmitted to the transmitter before the monitored time elapses, and
wherein, after the feedback message is transmitted, the method includes starting to monitor for generating a next feedback message.

19. The method of claim 17, further comprises:
receiving, from the transmitter, a control message for requesting a specific feature; and
responding for the control message in response that the control message has a message type that the receiver is able to understand,
wherein the control message is disregarded or discarded in response that the control message does not have the message type that the receiver is able to understand.

20. A transmitter that communicates with a receiver based on a target transmit rate for a forward path for packet transmission, the transmitter comprising:
a memory; and
processing circuitry configured to,
estimate a metric for determining a status of the forward path based on a feedback message including information received from the receiver on a packet previously transmitted by the transmitter,
determine the status of the forward path based on the metric,
determine the target transmit rate for the forward path based on the status of the forward path, and
control a transmit rate by the transmitter of the packet to the receiver at the target transmit rate,
wherein the metric reflects characteristics associated with the forward path from which influence by a backward path which is a path that the feedback message is transmitted is removed.
